(19) United States
(12) Patent Application Publication
(10) Pub. No.: US 2022/0160173 A1
(43) Pub. Date: May 26, 2022

(54) GRILL

(71) Applicant: Lodge Manufacturing Company, South Pittsburg, TN (US)

(72) Inventor: Kelly Peterson, Chattanooga, TN (US)

(21) Appl. No.: 17/112,365

(22) Filed: Dec. 4, 2020

Related U.S. Application Data
(63) Continuation-in-part of application No. 17/100,717, filed on Nov. 20, 2020, now abandoned.

(51) Int. Cl. A47J 37/07; F24B 13/02; F24B 5/02; A47J 36/02

(52) U.S. Cl. CPC A47J 37/0763; F24B 13/02; A47J 37/0704; A47J 36/02; A47J 37/0786; F24B 5/023

(57) ABSTRACT

Examples are disclosed that relate to grills and methods of controlling airflow into a grill. In one example, a grill comprises a cover comprising a grilling surface at a first end and a plurality of vents at a second end opposite to the first end. The grill further comprises a circular base configured to seat the second end of the cover. The circular base comprises a planar surface and a plurality of protrusions extending upwardly from the planar surface. The cover is rotatable relative to the circular base when seated on the circular base, and the protrusions are configured to selectively block and expose the plurality of vents in the cover upon rotation of the cover.

### CROSS REFERENCE TO RELATED APPLICATIONS

This application is a continuation-in-part of U.S. application Ser. No. 17/100,717, filed Nov. 20, 2020, the entirety of which is hereby incorporated herein by reference.

### BACKGROUND

Portable grills can be useful for many activities, including picnicking, camping, and tailgating. Some grills have a small form factor that is convenient for traveling and enhances their portability. However, some of these grills have loose or removeable components, such as handles, legs, grates, fasteners, and grilling surfaces, which may take time to assemble before use. Further, such components can fall out and become lost during use, cleaning, and/or travel. Additionally and in some examples, it can be challenging to control airflow to a fuel source in these grills, and to clean the grill after use.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Examples are disclosed that relate to grills and methods of controlling airflow into a grill. In one example, a grill comprises a cover comprising a grilling surface at a first end and a plurality of vents at a second end opposite to the first end. The grill further comprises a circular base configured to seat the second end of the cover. The circular base comprises a planar surface and a plurality of protrusions extending upwardly from the planar surface. The cover is rotatable relative to the circular base when seated on the circular base, and the protrusions are configured to selectively block and expose the plurality of vents in the cover upon rotation of the cover.

In another example a grill comprises a circular base comprising a planar surface and a plurality of protrusions extending upwardly from the planar surface around a circumference of the base. A plurality of ribs extends across the planar surface and are configured to receive fuel sources. The grill also includes a cover comprising a grilling surface at a first end and a plurality of vents at a second end opposite to the first end. The cover is rotatably seated on the circular base to selectively expose the vents via rotation of the cover relative to the circular base. When the cover is in a closed position relative to the circular base, the plurality of protrusions block the plurality of vents to substantially block airflow through the vents. When the cover is rotated from the closed position, the plurality of vents are exposed to allow airflow through the vent.

Another example provides a method of controlling airflow into a grill. The method comprises seating a cover onto a base. The cover comprises a grilling surface at a first end of a tapered cylinder. The tapered cylinder comprises a plurality of vents at a second end opposite to the first end. The base comprises a planar surface and a plurality of protrusions extending upwardly from the planar surface. The method further comprises rotating the cover to a closed position in which the plurality of protrusions block the plurality of vents to substantially block airflow through the vents. The method also includes rotating the cover away from the closed position to expose the plurality of vents and allow airflow through the vents.

### BRIEF DESCRIPTION OF THE DRAWINGS

FIG. 1 shows an example of a grill comprising a plurality of vents covered by a plurality of protrusions according to examples of the present disclosure.

FIG. 2 shows the grill of FIG. 1 in which the plurality of vents are fully exposed according to examples of the present disclosure.

FIG. 3 shows the grill of FIG. 1 in which the plurality of vents are partially covered by the plurality of protrusions according to examples of the present disclosure.

FIG. 4 shows an exploded view of the grill of FIG. 1 according to examples of the present disclosure.

FIG. 5 shows atop-down view of the base of the grill of FIG. 1 according to examples of the present disclosure.

FIG. 6 shows a side view of the base of the grill of FIG. 1 according to examples of the present disclosure.

FIG. 7 shows a cross section of a protrusion of the base according to examples of the present disclosure.

FIG. 8 shows a cover of the grill of FIG. 1 according to examples of the present disclosure.

FIGS. 9A and 9B show side views of the cover of FIG. 8 according to examples of the present disclosure.

FIG. 10 shows a flow diagram of an example method for controlling airflow into a grill.

### DETAILED DESCRIPTION

As noted above, portable grills can be useful for many activities, including picnicking, camping, and tailgating. Some grills have a small form factor that is convenient for traveling. However, some such portable grills have loose or removeable components, such as handles, legs, grates, fasteners, and grilling surfaces, which may take time to assemble before use. Further, such components can fall out during use, cleaning, and/or travel and become lost.

In some examples, it can also be challenging to control airflow to a fuel source inside the grill, and to clean the grill after use. For example, some kettle-shaped charcoal grills have vents located below a charcoal firebox and vents located in a lid positioned above a cooking surface. As the vents are not located directly adjacent to the charcoal, it can be difficult to precisely control airflow to the charcoal at the bottom of the grill. In addition, it can be an inconvenient and messy task to remove the charcoal after use, and to clean the cooking surface and the firebox.

Accordingly, examples are disclosed that relate to grills and methods of controlling airflow into a grill. Briefly, a grill comprises a cover comprising a grilling surface at a first end and a plurality of vents at a second end opposite to the first end. The grill further comprises a circular base configured to seat the second end of the cover. The circular base comprises a planar surface and a plurality of protrusions extending upwardly from the planar surface. The cover is easily and conveniently rotated relative to the circular base when seated on the circular base, and the protrusions are configured to selectively cover and expose the plurality of vents in the cover upon rotation of the cover. In this manner, a user can easily control airflow through the grill by simply rotating the cover. Further and as described further below, the grill is composed of just two parts and is easy to clean after use.

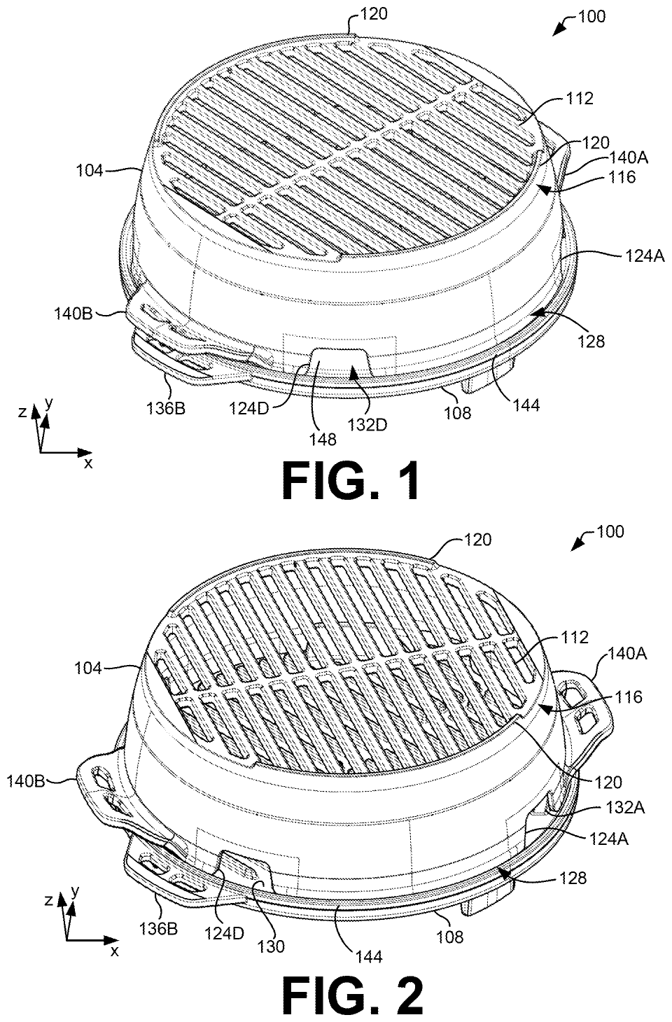

FIG. 1 shows one example of a grill 100. The grill 100 comprises a cover 104 and a circular base 108. In some examples, the cover 104 and the circular base 108 each take the form of a single cast-iron part. By forming the cover 104 and the circular base 108 as single cast-iron parts, the grill 100 is sturdy and easy to transport, assemble and use. For example, the cover 104 and the circular base 108 may be used immediately out of the box without further assembly, and the two-piece design of the grill 100 is easily portable.

The cover 104 comprises a grilling surface 112 at a first end 116. The grilling surface 112 is comprised of parallel, spaced-apart bars extending across the first end 116 of the cover 104. The cover 104 further comprises two raised rims 120 extending around opposing portions of the cover and upwardly from the grilling surface 112 in the positive z-axis direction. Advantageously, the raised rims 120 function to prevent round rollable foods, such as hot dogs, from rolling off the grilling surface 112. With reference briefly to FIG. 8, in this example the grilling surface 112 has a height of approximately 4.0 inches above the bottom of a second end 128 of the cover 104 that is opposite to the first end 116, and the raised rims 120 have a height of approximately 4.2 inches above the bottom of the second end of the cover.

With reference also to FIGS. 8, 9A, and 9B, the cover 104 also comprises a plurality of vents 124A, 124B, 124C, and 124D at a second end 128 that is opposite to the first end 116. As shown in FIGS. 1, 8, 9A, and 9B, these four vents 124A, 124B, 124C, and 124D are equally spaced around a peripheral face of the cover 104. In this example, each vent of the vents 124A, 124B, 124C, and 124D has a rounded rectangular shape that extends upwardly in the positive z-axis direction from the second end 128 towards the first end 116.

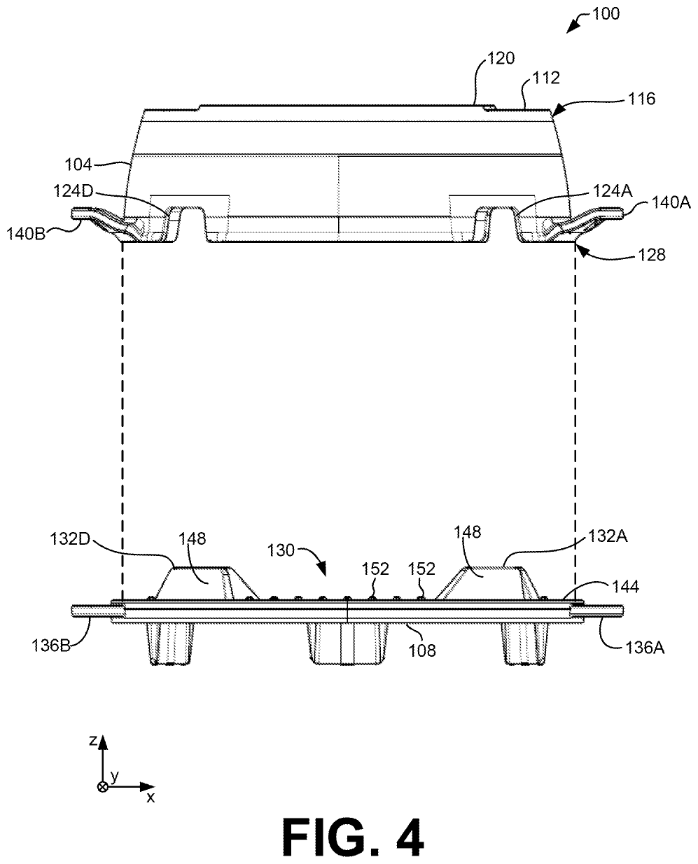

With reference also to FIG. 4, the cover 104 comprises a tapered cylinder shape. In this manner, the first end 116 has a smaller diameter than the second end 128. In one potential advantage of the present disclosure, this shape of the cover 104 also can encourage convection within the grill 100. In other examples, other suitable shapes may be utilized for the cover 104, such as a right cylinder or a conical frustum shape.

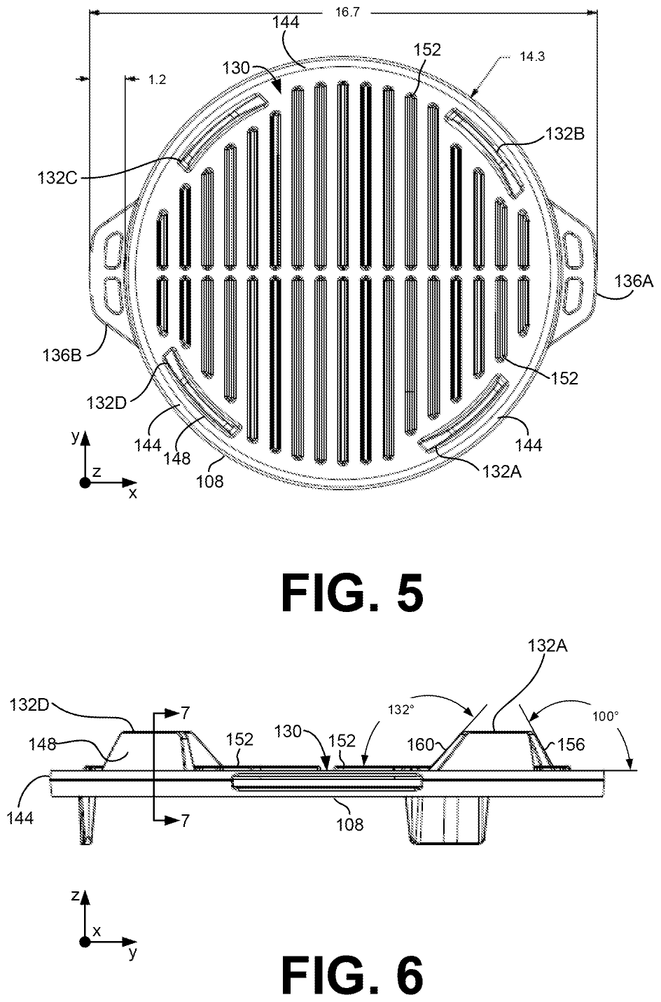

The circular base 108 of the grill 100 is configured to seat the second end 128 of the cover 104. With reference briefly to FIG. 5, the circular base 108 comprises a planar surface 130. The circular base 108 also comprises four protrusions 132A, 132B, 132C, and 132D. Each of the protrusions 132A, 132B, 132C, and 132D extends upwardly from the circular base 108 in the z-axis direction. The four protrusions 132A, 132B, 132C, and 132D each have the same shape and are equally spaced around a circumference of the base 108 to match the spacing of the four vents 124A, 124B, 124C, and 124D. As described in more detail below with reference to FIG. 6, each protrusion 132A, 132B, 132C, and 132D has a sloped shape that cooperates with the shape of the vents 124A, 124B, 124C, and 124D to allow a user to precisely control the amount each vent is exposed or blocked, and thereby exercise fine control over the airflow into the charcoal or other fuel source at the bottom portion of the grill. Further, the configuration of the cover 104 and base 108 enable a user to easily and simply perform such precise control by simply rotating the seated cover relative to the base.

To enable this precision airflow control, a surface area of an outer face of each protrusion 132A, 132B, 132C, or 132D is greater than an area of a corresponding vent 124A, 124B, 124C, or 124D. In this manner, and as illustrated by example in FIG. 1, the protrusions 132A, 132B, 132C, and 132D block the corresponding vents 124A, 124B, 124C, and 124D when the cover 104 is seated on the base 108 in this closed position. In this manner and in this closed position, the protrusions 132A, 132B, 132C, and 132D block and close off the vents 124A, 124B, 124C, and 124D, thereby substantially preventing airflow through the vents.

As noted above, and in one potential advantage of the present disclosure, a user may easily control airflow into the grill 100 via the vents 124A, 124B, 124C, and 124D by simply rotating the cover 104 relative to the base 108. More particularly, the base 108 is configured to receive and seat the cover 104 such that the cover 104 is freely rotatable relative to the base 108. Advantageously, this configuration enables the protrusions 132A, 132B, 132C, and 132D to selectively block and expose the vents 124A, 124B, 124C, and 124D in the cover 104 by simply rotating the base 108, and without translation of the cover 104 away from the base 108 in the z-axis direction. In this manner, this configuration allows the user to easily adjust airflow by simply rotating the cover 104 without the need to lift or raise the cover.

FIG. 6 shows a side view of the base 108 of the grill 100. In this example, a first side 156 of each protrusion 132 forms a first angle with the planar surface 130 of 100 degrees. A second side 160 of the protrusion opposite to the first side 156 forms a second angle with the planar surface 130 that is greater than the first angle, such as 132 degrees. In this manner, the shape of the protrusions 132A, 132B, 132C, and 132D cooperates with the shape of the vents 124A, 124B, 124C, and 124D to enable precise control of an exposed area of the vents. In other examples, other suitable angles of the first side 156 and second side 160 of each protrusion 132 with respect to the planar surface 130 may be utilized.

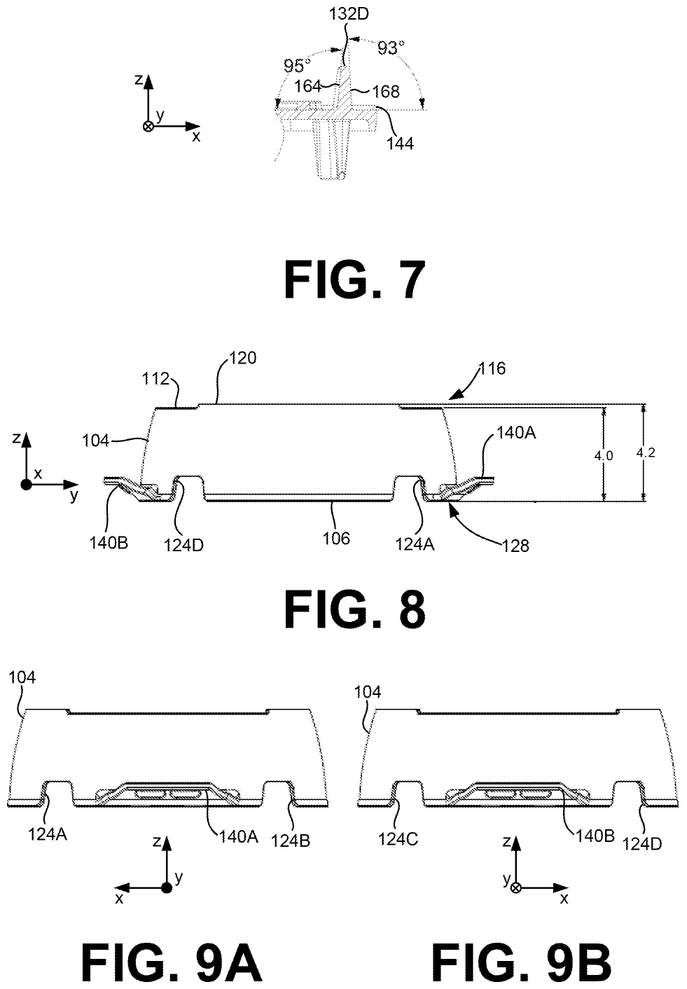

FIG. 7 shows a partial cross section of one of the protrusions 132D through line 7-7 of FIG. 6. In this example, an internal side 164 of the protrusion 132D forms an angle with the planar surface 130 of 95 degrees. An outer face 148 of the protrusion 132D forms an angle with the planar surface 130 of 93 degrees. In other examples, other suitable angles may be utilized.

With reference now to FIG. 2, the plurality of vents 124A, 124B, 124C, and 124D are at least partially exposed when the cover 104 is rotated away from the closed position. As illustrated by example in FIG. 2, when the cover 104 is rotated approximately 25 degrees clockwise relative to the base 108 and away from the closed position illustrated in FIG. 1, the vents 124A, 124B, 124C, and 124D are fully exposed to allow airflow into an interior of the grill 100 where a fuel source (e.g. charcoal) may be located. In this manner, the vents 124A, 124B, 124C, and 124D may be selectively opened and closed by any desired amount to adjust ventilation through the grill 100.

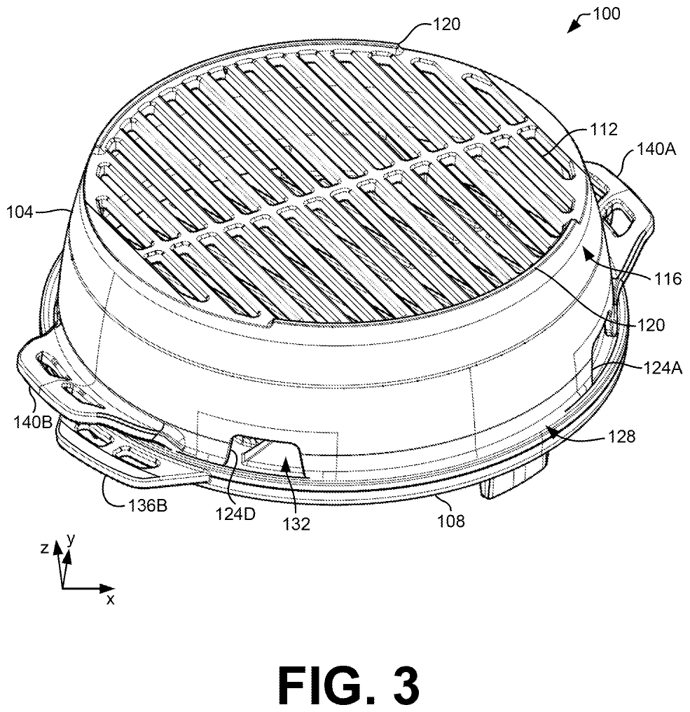

In the present example, 25 degrees is the smallest rotation angle that completely exposes each of the vents 124A, 124B, 124C, and 124D. In this example, rotating the cover 104 between 0 and 25 degrees from the closed position exposes between 0% and 100%, respectively, of an area of each vent. In this manner, rotation of the cover 104 provides a broad range of control over airflow through the grill 100. For example, and with reference now to FIG. 3, the cover 104 is rotated from the closed position approximately 12.5 degrees clockwise relative to the base 108. In this manner, a portion of each vent of the plurality of vents 124A, 124B, 124C, and 124D is blocked by one of the protrusions, and another portion of each vent is exposed to the interior of the grill 100. In this manner, the airflow into the vents 124A, 124B, 124C, and 124D may be feathered to enable finer control over airflow through the grill 100.

FIG. 4 shows an exploded view of the grill 100. As illustrated in FIG. 4, the circular base 108 is configured to seat the second end 128 of the cover 104. With reference also to FIG. 5, which shows a top-down view of the base 108 of the grill 100, in this example the circular base 108 comprises a lip 144 extending upwardly from the base 108 in the z-axis direction around the entire circumference of the base 108. An outer face 148 of each of the protrusions 132A, 132B, 132C, and 132D is spaced from the lip 144 to create a gap between the outer face 148 and the lip 144. The second end 128 of the cover 104 is received in these gaps. In this manner, portions of the second end 128 of the cover 104 are moveably retained in the gaps between the lip 144 and the outer faces 148 of the protrusions 132A, 132B, 132C, and 132D, to thereby allow the cover to rotate relative to the circular base 108 while being secured between the lip 144 and the outer faces of the protrusions.

In other examples, the circular base 108 comprises two or more lips extending upwardly from the base 108 in the z-axis direction around portions of the circumference of the base 108. For example, a separate lip may be positioned adjacent to each of the protrusions 132A, 132B, 132C, and 132D to create gaps therebetween for receiving the second end 128 of the cover 104.

With reference again to FIGS. 2 and 3, by positioning the vents 124A, 124B, 124C, and 124D laterally adjacent to the planar surface 130 of the base 108, more direct airflow is provided to a fuel source (e.g., charcoal) located on the planar surface 130. Furthermore, and with reference to FIGS. 5 and 6, with the cover 104 removed the planar surface 130 is substantially unobstructed in the XY-plane between the protrusions 132A, 132B, 132C, and 132D. Advantageously, this configuration allows a user to easily remove the fuel source and clean the base 108 after cooking.

With reference to FIGS. 4 and 5, the base 108 comprises a plurality of ribs 152. Each rib 152 extends upwardly from the planar surface 130 in the positive Z-axis direction. Each rib 152 also extends across the planar surface 130 along the Y-axis. The plurality of ribs 152 are configured to receive fuel sources. For example, burning charcoal may be distributed across the ribs 152. In this manner, the ribs 152 may allow airflow under the charcoal.

In some examples, and as shown in the example of FIGS. 1-5, the base 108 includes a first base handle 136A and a second base handle 136B located on opposite sides of the base. In the example of FIG. 5, each of the base handles 136A, 136B extends approximately 1.2 inches away from the base 108 in the X-axis direction. In this example the base 108 has a diameter of approximately 14.3 inches, giving the base 108 an overall length in the X-axis direction of approximately 16.7 inches from handle to handle. In other examples, the base 108 may have other suitable dimensions that correspond with the configuration of the cover 104 as described herein.

With reference now to FIGS. 1, 2 and 8, the cover 104 further comprises a first cover handle 140A and a second cover handle 140B located on opposite sides of the cover 104 that enable a user to easily rotate and reposition the cover relative to the base 108. As shown in FIGS. 1 and 8, the cover handles 140A, 140B are each angled upwardly to create space between the cover handles and the corresponding base handles 136A, 136B. In this manner, a user can easily access the cover handles 140A, 140B with, for example, engagement hooks or other tools that enable the user to safely rotate and/or remove the cover 104 while keeping hands distanced from the cover. As shown in FIG. 1, the cover handles 140A, 140B are also configured to overlap and vertically align with the base handles 136A, 136B when the plurality of vents 124A, 124B, 124C, and 124D are covered by the plurality of protrusions 132A, 132B, 132C, and 132D. In this closed position, this alignment of the base handles 136A, 136B and the cover handles 140A, 140B also provides a convenient visual indicator to the user that the vents are closed.

From this position, a user can easily access the cover handles 140A, 140B to turn the cover 104 relative to the base and expose the vents 124A, 124B, 124C, and 124D. As shown in FIG. 2, when the vents 124A, 124B, 124C, and 124D are exposed, the cover handles 140A, 140B are clearly offset from the base handles 136A, 136B. In this manner, the base handles 136A, 136B and the cover handles 140A, 140B also provide an immediate and clear visual indicator to the user that the vents are open.

FIGS. 9A and 9B show the cover 104 rotated 90 degrees clockwise and 90 degrees counterclockwise, respectively, about the Z-axis from the perspective of FIG. 8. As illustrated by example in FIG. 9A, the first cover handle 140A is located between first vent 124A and second vent 124B in the cover 104. FIG. 9B shows the second cover handle 140B located opposite to the first cover handle 140A between third vent 124C and fourth vent 124D.

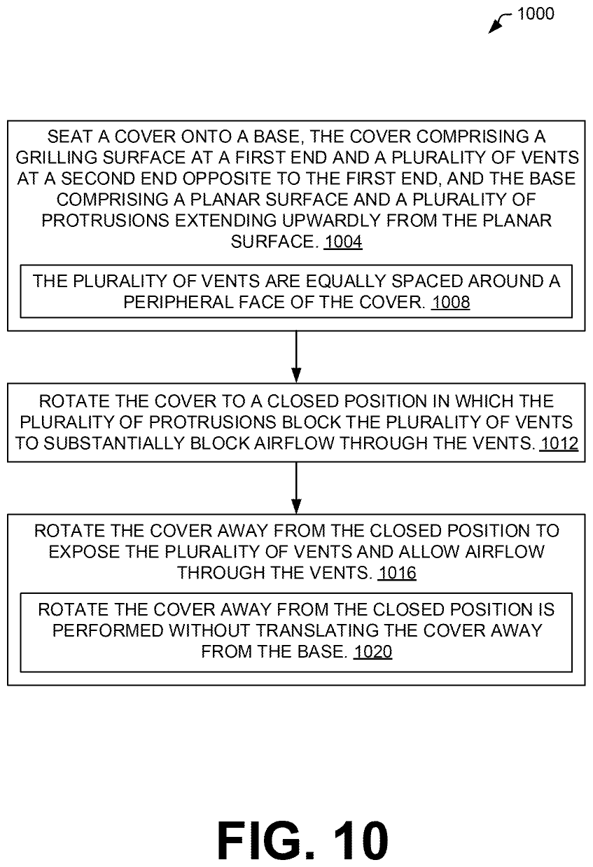

With reference now to FIG. 10, a flow diagram is illustrated depicting an example method 1000 for controlling airflow into a grill. The following description of method 1000 is provided with reference to the components described herein and shown in FIGS. 1-9. It will be appreciated that the following description of method 1000 is provided by way of example and is not meant to be limiting. Therefore, it is to be understood that method 1000 may include additional and/or alternative steps relative to those illustrated in FIG. 10. Further, it is to be understood that the steps of method 1000 may be performed in any suitable order. Further still, it is to be understood that one or more steps may be omitted from method 1000 without departing from the scope of this disclosure. It will also be appreciated that method 1000 also may be performed in other contexts using other suitable components.

At 1004, the method 1000 includes seating a cover onto a base, the cover comprising a grilling surface at a first end and a plurality of vents at a second end opposite to the first end, and the base comprising a planar surface and a plurality of protrusions extending upwardly from the planar surface. At 1008, the method 1000 may include wherein the plurality of vents are equally spaced around a peripheral face of the cover.

At 1012, the method 1000 includes rotating the cover to a closed position in which the plurality of protrusions block the plurality of vents to substantially block airflow through the vents. At 1016, the method 1000 includes rotating the cover away from the closed position to expose the plurality of vents and allow airflow through the vents. At 1020, the method 1000 may include wherein rotating the cover away from the closed position is performed without translating the cover away from the base.

The following paragraphs provide additional support for the claims of the subject application.

One aspect provides a grill comprising: a cover comprising a grilling surface at a first end and a plurality of vents at a second end opposite to the first end; and a circular base configured to seat the second end of the cover, the circular base comprising a planar surface and a plurality of protrusions extending upwardly from the planar surface, wherein the cover is rotatable relative to the circular base when seated on the circular base, and the protrusions are configured to selectively block and expose the plurality of vents in the cover upon rotation of the cover.

The grill may additionally or alternatively include, wherein the plurality of protrusions block the plurality of vents when the cover is seated on the circular base in a closed position to substantially block airflow through the vents. The grill may additionally or alternatively include, wherein the vents are at least partially exposed when the cover is rotated away from the closed position to allow airflow through the vents.

The grill may additionally or alternatively include, wherein the cover is a single cast-iron part and the base is a single cast-iron part. The grill may additionally or alternatively include, wherein a number of the protrusions in the base equals a number of the vents at the second end of the cover. The grill may additionally or alternatively include, wherein the protrusions are equally spaced around a circumference of the base.

The grill may additionally or alternatively include, wherein the vents are equally spaced around a peripheral face of the cover. The grill may additionally or alternatively include, wherein the plurality of protrusions have the same shape. The grill may additionally or alternatively include, wherein the circular base comprises a lip extending upwardly around one or more portions of a circumference of the base, and wherein an outer face of each protrusion is spaced from the lip to create a gap between the outer face and the lip in which the second end of the cover is received.

The grill may additionally or alternatively include, wherein a surface area of an outer face of the protrusion is greater than an area of the vent. The grill may additionally or alternatively include, wherein a first side of the protrusion forms a first angle with the planar surface, and a second side of the protrusion opposite to the first side forms a second angle with the planar surface that is greater than the first angle.

The grill may additionally or alternatively include, wherein the cover comprises: a first cover handle extending from the cover and located between a first vent and a second vent of the plurality of vents; and a second cover handle extending from the cover at a location opposite to the first cover handle, the second cover handle located between a third vent and a fourth vent of the plurality of vents. The grill may additionally or alternatively include, wherein the circular base comprises: a first base handle extending from a peripheral area of the base and located between a first protrusion and a second protrusion of the plurality of protrusions; and a second base handle extending from another peripheral area of the base at a location opposite to the first base handle, the second base handle located between a third protrusion and a fourth protrusion of the plurality of protrusions. The grill may additionally or alternatively include, wherein the protrusions are configured to selectively block and expose the plurality of vents in the cover without translation of the cover away from the base.

Another aspect provides a grill comprising: a circular base comprising a planar surface, a plurality of protrusions extending upwardly from the planar surface around a circumference of the base, and a plurality of ribs extending across the planar surface and configured to receive fuel sources; and a cover comprising a grilling surface at a first end and a plurality of vents at a second end opposite to the first end, the cover rotatably seated on the circular base to selectively expose the vents via rotation of the cover relative to the circular base; wherein, when the cover is in a closed position relative to the circular base, the plurality of protrusions block the plurality of vents to substantially block airflow through the vents; and wherein, when the cover is rotated from the closed position, the plurality of vents are exposed to allow airflow through the vent.

The grill may additionally or alternatively include, wherein the cover is a single cast-iron part and the base is a single cast-iron part. The grill may additionally or alternatively include, wherein the protrusions are configured to selectively block and expose the plurality of vents in the cover without translation of the cover away from the base.

Another aspect provides a method of controlling airflow into a grill, the method comprising: seating a cover onto a base, the cover comprising a grilling surface at a first end and a plurality of vents at a second end opposite to the first end, and the base comprising a planar surface and a plurality of protrusions extending upwardly from the planar surface; rotating the cover to a closed position in which the plurality of protrusions block the plurality of vents to substantially block airflow through the vents; and rotating the cover away from the closed position to expose the plurality of vents and allow airflow through the vents.

The method may additionally or alternatively include, wherein rotating the cover away from the closed position is performed without translating the cover away from the base. The method may additionally or alternatively include, wherein the plurality of vents are equally spaced around a peripheral face of the cover.

It will be appreciated that references to “one example” or “an example” are not intended to be interpreted as excluding the existence of additional embodiments that also incorporate the recited features. Unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects. The term “adjacent” is used to mean that a first element or structure is nearby or in close proximity to a second element or structure, and includes the first and second elements or structures being in contact and not in contact.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

It will be understood that the configurations and/or approaches described herein are exemplary in nature, and that these specific embodiments or examples are not to be considered in a limiting sense, because numerous variations are possible. The specific routines or methods described herein may represent one or more of any number of manufacturing and/or usage strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A grill comprising:
a cover comprising a grilling surface at a first end and a plurality of vents at a second end opposite to the first end; and
a circular base configured to seat the second end of the cover, the circular base comprising a planar surface and a plurality of protrusions extending upwardly from the planar surface, wherein the cover is rotatable relative to the circular base when seated on the circular base, and the protrusions are configured to selectively block and expose the plurality of vents in the cover upon rotation of the cover.

2. The grill of claim 1, wherein the plurality of protrusions block the plurality of vents when the cover is seated on the circular base in a closed position to substantially block airflow through the vents.

3. The grill of claim 2, wherein the vents are at least partially exposed when the cover is rotated away from the closed position to allow airflow through the vents.

4. The grill of claim 1, wherein the cover is a single cast-iron part and the base is a single cast-iron part.

5. The grill of claim 1, wherein a number of the protrusions in the base equals a number of the vents at the second end of the cover.

6. The grill of claim 1, wherein the protrusions are equally spaced around a circumference of the base.

7. The grill of claim 1, wherein the vents are equally spaced around a peripheral face of the cover.

8. The grill of claim 1, wherein the plurality of protrusions have a same shape.

9. The grill of claim 1, wherein the circular base comprises a lip extending upwardly around one or more portions of a circumference of the base, and wherein an outer face of each protrusion is spaced from the lip to create a gap between the outer face and the lip in which the second end of the cover is received.

10. The grill of claim 1, wherein a surface area of an outer face of the protrusion is greater than an area of the vent.

11. The grill of claim 1, wherein a first side of the protrusion forms a first angle with the planar surface, and a second side of the protrusion opposite to the first side forms a second angle with the planar surface that is greater than the first angle.

12. The grill of claim 1, wherein the cover comprises:
a first cover handle extending from the cover and located between a first vent and a second vent of the plurality of vents; and
a second cover handle extending from the cover at a location opposite to the first cover handle, the second cover handle located between a third vent and a fourth vent of the plurality of vents.

13. The grill of claim 1, wherein the circular base comprises:
a first base handle extending from a peripheral area of the base and located between a first protrusion and a second protrusion of the plurality of protrusions; and
a second base handle extending from another peripheral area of the base at a location opposite to the first base handle, the second base handle located between a third protrusion and a fourth protrusion of the plurality of protrusions.

14. The grill of claim 1, wherein the protrusions are configured to selectively block and expose the plurality of vents in the cover without translation of the cover away from the base.

15. A grill comprising:
a circular base comprising
a planar surface,
a plurality of protrusions extending upwardly from the planar surface around a circumference of the base, and
a plurality of ribs extending across the planar surface and configured to receive fuel sources; and
a cover comprising a grilling surface at a first end and a plurality of vents at a second end opposite to the first end, the cover rotatably seated on the circular base to selectively expose the vents via rotation of the cover relative to the circular base;
wherein, when the cover is in a closed position relative to the circular base, the plurality of protrusions block the plurality of vents to substantially block airflow through the vents; and
wherein, when the cover is rotated from the closed position, the plurality of vents are exposed to allow airflow through the vent.

16. The grill of claim 15, wherein the cover is a single cast-iron part and the base is a single cast-iron part.

17. The grill of claim 15, wherein the protrusions are configured to selectively block and expose the plurality of vents in the cover without translation of the cover away from the base.

18. A method of controlling airflow into a grill, the method comprising:
seating a cover onto a base, the cover comprising a grilling surface at a first end and a plurality of vents at a second end opposite to the first end, and the base comprising a planar surface and a plurality of protrusions extending upwardly from the planar surface;
rotating the cover to a closed position in which the plurality of protrusions block the plurality of vents to substantially block airflow through the vents; and
rotating the cover away from the closed position to expose the plurality of vents and allow airflow through the vents.

19. The method of claim 18, wherein rotating the cover away from the closed position is performed without translating the cover away from the base.

20. The method of claim 18, wherein the plurality of vents are equally spaced around a peripheral face of the cover.
